(19) United States
(12) Patent Application Publication
(10) Pub. No.: US 2024/0307966 A1
(43) Pub. Date: Sep. 19, 2024

(54) METHODS OF FORMING HEAT EXCHANGERS BY DIRECTED ENERGY DEPOSITION ADDITIVE MANUFACTURING AND RELATED HEAT EXCHANGERS AND REACTOR ASSEMBLIES

(71) Applicants: Battelle Energy Alliance, LLC, Idaho Falls, ID (US); University of Idaho, Moscow, ID (US)

(72) Inventors: Piyush Sabharwall, Idaho Falls, ID (US); Isabella J. van Rooyen, Idaho Falls, ID (US); Luis Nunez, III, Idaho Falls, ID (US); Richard Christensen, Idaho Falls, ID (US)

(21) Appl. No.: 18/606,241

(22) Filed: Mar. 15, 2024

Related U.S. Application Data
(60) Provisional application No. 63/490,925, filed on Mar. 17, 2023.

(51) Int. Cl. B22F 10/38; B22F 5/00; B22F 10/25; B33Y 10/00; B33Y 80/00

(52) U.S. Cl. CPC B22F 10/38; B22F 5/00; B22F 10/25; B33Y 10/00; B33Y 80/00; B22F 2301/35; B22F 2999/00

(57) ABSTRACT

A method of forming a heat exchanger including selecting process parameters for a directed energy deposition (DED) additive manufacturing process for forming a housing and channels within the housing of a heat exchanger and forming the channels within the housing using the process parameters of the DED additive manufacturing process. The inner walls of the channels have hydrophobic or superhydrophobic surface properties, and the inner walls of the channels exhibit an as-fabricated surface roughness factor within a range from about 1.0 to about 2.5. A heat exchanger and a reactor assembly comprising a nuclear reactor and a heat exchanger are also disclosed.

### CROSS-REFERENCE TO RELATED APPLICATION

This application claims the benefit under 35 U.S.C. § 119(e) of U.S. Provisional Patent Application Ser. No. 63/490,925, filed Mar. 17, 2023, the disclosure of which is hereby incorporated herein in its entirety by this reference.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### TECHNICAL FIELD

The disclosure relates generally to heat exchangers and related methods. More particularly, the present disclosure relates to surface properties of heat exchangers and associated methods of forming the heat exchangers.

### BACKGROUND

Heat exchangers having small hydraulic diameters are prone to pressure drop and the buildup of sediment due to fouling over the lifespan of the heat exchangers. Fouling tends to increase with temperature and reduced flow rate. Increases in fouling lead to decreases in the performance of the heat exchangers. Conventional heat exchangers have increased operational costs due to fouling and the need to repair, clean, and replace various parts subject to fouling during the lifespan of the heat exchanger. Repairing, cleaning, and replacing the parts also takes the heat exchanger offline for a period of time.

### SUMMARY

An embodiment of the disclosure includes a method of forming a heat exchanger. The method including selecting process parameters for a directed energy deposition (DED) additive manufacturing process for forming a housing and channels within the housing of a heat exchanger; and forming the channels within the housing using the process parameters of the DED additive manufacturing process. The inner walls of the channels having hydrophobic or superhydrophobic surface properties, wherein the inner walls of the channels exhibit an as-fabricated surface roughness factor within a range from about 1.0 to about 2.5.

Another embodiment of the disclosure includes a heat exchanger, the heat exchanger comprising a housing and channels within the housing and defining fluid passageways. The inner walls of the channels exhibit high, as-fabricated hydrophobic or superhydrophobic surface properties. The channels exhibit an inner diameter within a range from about 0.1 mm to about 5 mm.

Another embodiment of the disclosure includes a reactor assembly, the reactor assembly including a nuclear reactor; and a heat exchanger operatively connected to the nuclear reactor. The heat exchanger includes channels distributed throughout the heat exchanger, the inner walls of the channels exhibiting hydrophobic or superhydrophobic surface properties.

### BRIEF DESCRIPTION OF THE DRAWINGS

FIG. 1 is a perspective view of a heat exchanger in accordance with embodiments of the disclosure;

FIG. 2 is a perspective cross section of a fluid passageway of the heat exchanger of FIG. 1;

FIG. 3 is a graph representing pressure distribution in accordance with embodiments of the disclosure;

FIG. 4 is a graph representing pressure distribution in accordance with embodiments of the disclosure;

FIG. 5 is a graph representing temperature distribution in accordance with embodiments of the disclosure;

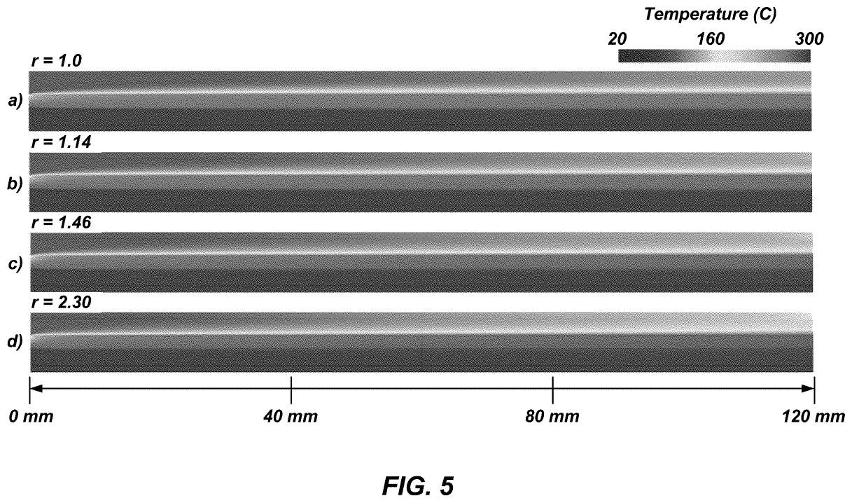

FIG. 6 is a graph representing a relationship of contact angle and apparent contact angle in accordance with embodiments of the disclosure;

FIG. 7 is a graph representing a relationship of contact angle and apparent contact angle in accordance with embodiments of the disclosure;

FIG. 8 is a graph representing a relationship of contact angle and apparent contact angle in accordance with embodiments of the disclosure;

FIG. 9 is a schematic of a liquid droplet on a rough surface and represents contact angle and solid-liquid fractions on the rough surface in accordance with embodiments of the disclosure; and

FIG. 10 is a graph representing velocity distribution in accordance with embodiments of the disclosure.

### DETAILED DESCRIPTION

In the brief summary above and in the detailed description, the claims, and in the accompanying drawings, reference is made to particular features (including method acts) of the present disclosure. It is to be understood that the disclosure includes all possible combinations of such features. For example, where a particular feature is disclosed in the context of a particular embodiment, or a particular claim, that feature may also be used, to the extent possible, in combination with and/or in the context of other aspects and embodiments described herein.

The following description provides specific details, such as components, assembly, and materials in order to provide a thorough description of embodiments of the disclosure. However, a person of ordinary skill in the art will understand that the embodiments of the disclosure may be practiced without employing these specific details.

The use of the term “for example,” means that the related description is explanatory, and though the scope of the disclosure is intended to encompass the examples and legal equivalents, the use of such term is not intended to limit the scope of an embodiment or this disclosure to the specified components, acts, features, functions, or the like.

Drawings presented herein are for illustrative purposes and are not necessarily meant to be actual views of any particular material, component, structure, or device. Thus, embodiments described herein are not to be construed as being limited to the particular shapes or regions as illustrated, but include deviations in shapes that result, for example, from manufacturing. For example, a region illustrated or described as box-shaped may have rough and/or nonlinear features, and a region illustrated or described as round may include some rough and/or linear features. Moreover, sharp angles that are illustrated may be rounded, and vice versa. Thus, the regions illustrated in the figures are schematic in nature, and their shapes are not intended to illustrate the precise shape of a region and do not limit the scope of the present claims. The drawings are not necessarily to scale. Additionally, elements common between figures may retain the same numerical designation.

As used herein, the term “configured to” in reference to a structure or device intended to perform some function refers to size, shape, material composition, material distribution, orientation, and/or arrangement, etc., of the referenced structure or device.

As used herein, the terms “comprising” and “including,” and grammatical equivalents thereof are inclusive or open-ended terms that do not exclude additional, unrecited elements or method acts, but also include the more restrictive terms such as “consisting of” and “consisting essentially of” and grammatical equivalents thereof.

As used herein, the term “may” with respect to a material, structure, feature, or method act indicates that such is contemplated for use in implementation of an embodiment of the disclosure and such term is used in preference to the more restrictive term “is” so as to avoid any implication that other, compatible materials, structures, features and methods usable in combination therewith should or must be excluded.

As used herein, the singular forms “a,” “an,” and “the” include the plural forms as well, unless the context clearly indicates otherwise.

As used herein, the term “and/or” includes any and all combinations of one or more of the associated listed items.

As used herein, relational terms, such as “first,” “second,” etc., are used for clarity and convenience in understanding the disclosure and accompanying drawings and does not connote or depend on any specific preference, orientation, or order, except where the context clearly indicates otherwise.

As used herein, the term “about,” when used in reference to a numerical value for a particular parameter, is inclusive of the numerical value and a degree of variance from the numerical value that one of ordinary skill in the art would understand is within acceptable tolerances for the particular parameter. For example, “about,” in reference to a numerical value, may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, the term “substantially” in reference to a given parameter, property, or condition means and includes to a degree that one of ordinary skill in the art would understand that the given parameter, property, or condition is met with a degree of variance, such as within acceptable tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

While embodiments of this disclosure have been described and illustrated herein with respect to specific heat exchanger devices, those of ordinary skill in the art will recognize and appreciate that features and elements from different embodiments may be combined to arrive at further, additional types of heat exchanger devices and methods as contemplated by the inventors.

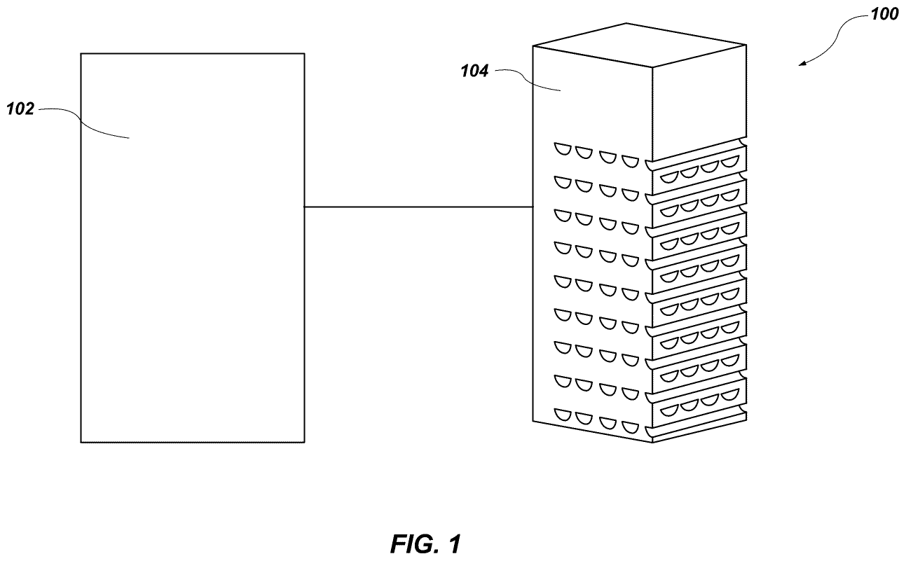

FIG. 1 shows an example of a reactor assembly 100 including a reactor 102 and one or more thermal management systems (e.g., heat exchangers 104). The heat exchanger 104 may be a compact heat exchanger, such as having a diameter of less than about 5.0 mm of one or more fluid passageways. By way of example only, the heat exchanger 104 may be a plate and frame heat exchanger, a brazed plate welded plate heat exchanger, a plate-fin heat exchanger, a brazed plate-fin heat exchanger, a diffusion-bonded plate-fin heat exchanger, a spiral heat exchanger, a plate and shell heat exchanger, or a polymer or printed circuit heat exchanger. The heat exchanger 104 may comprise any one or a combination of the foregoing heat exchangers. The heat exchanger 104 may be operatively connected to the reactor 102. The reactor 102 may be a nuclear reactor, chemical reactor, or any other type of reactor that may utilize a heat exchanger. The overall size and output of the heat exchanger 104 may be determined based on the type of reactor that the heat exchanger 104 is connected to and the desired output of the heat exchanger 104. The heat exchanger 104 may be used in combination with gas or molten salt working fluids. Additionally, the heat exchanger may be used to replace a combustion chamber such as in a Brayton cycle. While FIG. 1 illustrates the heat exchanger 104 in a reactor 102, the heat exchanger 104 may be used in other thermal systems, such as in the mechanical, aerospace, or oil and gas industries. The reactor 102 may be a molten salt reactor.

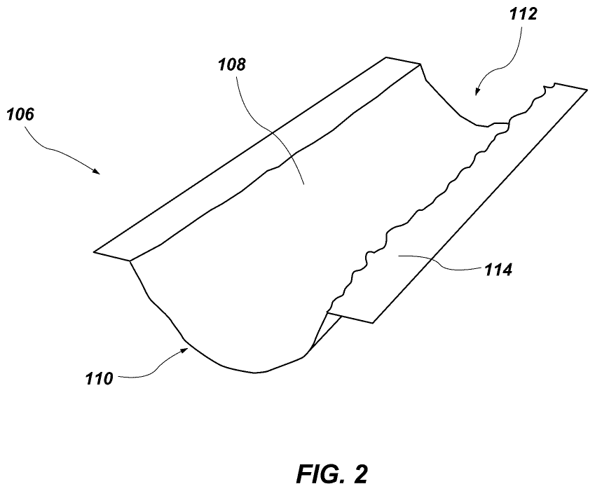

The heat exchanger 104 includes a housing surrounding fluid passageways 106 in the heat exchanger 104. FIG. 2 shows a cross-sectional perspective view of a portion of the fluid passageway 106 of the heat exchanger 104. The fluid passageway 106 may include an inner wall 108 that defines a channel, an inlet 110 and an outlet 112. The inner wall 108 of the fluid passageway 106 may exhibit a rough surface compared to the surface roughness of fluid passageways in conventional heat exchangers. The roughness of the surface of the inner wall 108 may be present as formed. In other words, the surface of the inner wall 108 is not roughened after formation of the inner wall 108. Instead, the roughened surface of the inner wall 108 may be formed by an additive manufacturing process used to form the fluid passageway 106. By increasing the surface roughness, reduced fouling and/or reduced pressure loss may be achieved in the fluid passageway 106 according to embodiments of the disclosure even in a harsh and aggressive chemical environment. The fluid passageway 106 of the heat exchanger 104 according to embodiments of the disclosure may be more resistant to fouling and may provide increased overall heat transfer performance without increasing the pressure drop within the fluid passageway 106. Therefore, the lifetime of the heat exchanger 104 is increased.

The fluid passageway 106 may be any length and have any overall geometric shape depending on the intended use of the heat exchanger 104. The fluid passageway 106 may exhibit a substantially cylindrical shape, a substantially rectangular shape, a substantially octagonal shape, a substantially triangular shape, among others, that are configured to facilitate heat transfer of a fluid therein. In some embodiments, the fluid passageway 106 exhibits a substantially cylindrical shape. In addition, the fluid passageway 106 may exhibit different shapes in different regions. For example, the fluid passageway 106 may exhibit a rectangular shape in a region where the fluid passageway 106 interfaces with a reactor and a circular or other shape in a downstream portion of the fluid passageway 106. The inlet 110 and the outlet 112 may be in communication with components of the reactor 102 and/or components of a Brayton cycle such as a compressor and/or a turbine.

The fluid passageway 106 may be formed of a material having properties that facilitate heat transfer, such as a metal. The material may be titanium, aluminum, stainless steel or nickel-based alloys. In some embodiments, the fluid passageway comprises 316L stainless steel.

The diameter of the fluid passageway 106 may be within a range from about 0.2 mm to about 5.0 mm, such as from about 1.0 mm to about 3.5 mm, from about 1.2 mm to about 3.4 mm, from about 2.0 mm to about 5.0 mm, from about 2.5 mm to about 5.0 mm, from about 3.0 mm to about 5.0 mm, from about 1.0 mm to about 3.0 mm, from about 1.0 mm to about 2.5 mm, or from about 1.0 mm to about 2.0 mm. The diameter of the fluid passageway may be substantially constant along its length. Alternatively, the diameter of the fluid passageway 106 may exhibit different diameters in different portions of its length.

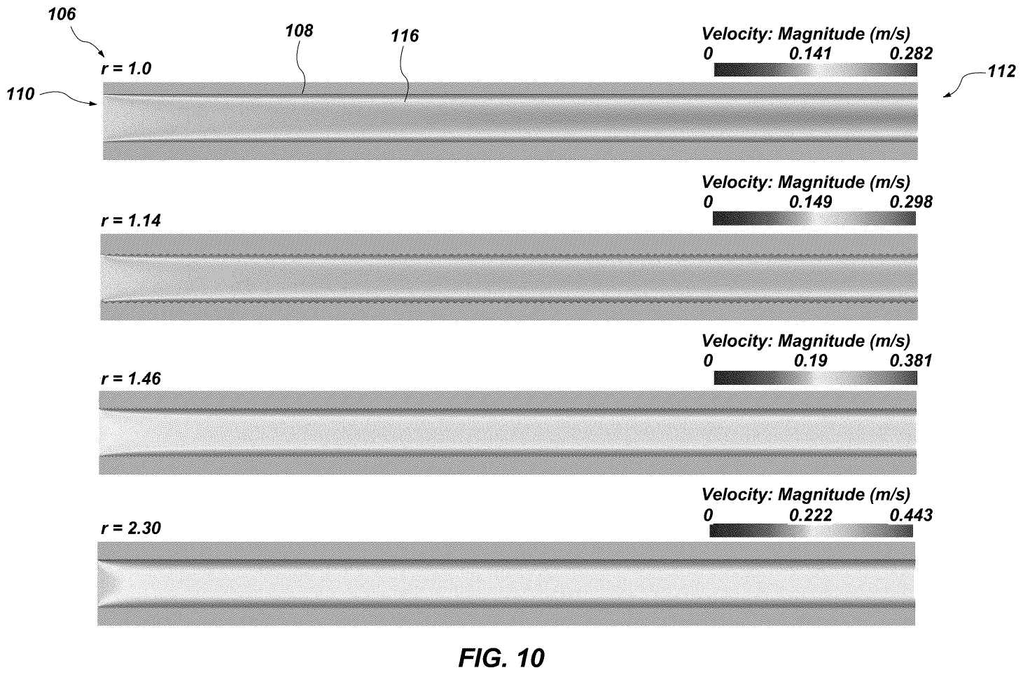

The overall size (e.g., dimensions) of the fluid passageway 106 may be determined by the desired output of the heat exchanger 104. The overall size of the fluid passageway 106 may affect the velocity at which a fluid passes through the fluid passageway 106. Several other factors may also affect the velocity at which the fluid passes through the fluid passageway 106, such as temperature and pressure within the fluid passageway 106, a roughness factor of the inner wall 108, and a contact angle of the fluid with the inner wall 108. The temperature and pressure within the fluid passageway 106 may be determined by the output from the reactor 102. The overall size of the fluid passageway 106 and the surface roughness of the inner wall 108 may be changed to affect the contact angle of the fluid with the inner wall 108 and control (e.g., regulate) the velocity of the fluid within the fluid passageway and the overall efficiency of the heat exchanger 104. The velocity of the fluid within the fluid passageway 106 may vary from the inner wall 108 to the center of the fluid passageway 106. The fluid may travel faster in the center of the fluid passageway 106 relative to near the inner wall 108. The velocity of the fluid within the fluid passageway 106 may range from about 0.05 m/s near the inner wall 108 to about 0.5 m/s near the center of the fluid passageway 106. In some embodiments, the velocity of the fluid within the fluid passageway 106 may range from about 0.05 m/s near the inner wall 108 to about 0.4 m/s near the center of the fluid passageway 106, from about 0.1 m/s near the inner wall 108 to about 0.3 m/s near the center of the fluid passageway 106, from about 0.15 m/s near the inner wall 108 to about 0.3 m/s near the center of the fluid passageway 106, or a combination thereof. The different velocity of the fluid near the inner wall 108 and the center of the fluid passageway 106 produces a velocity gradient 116 (see FIG. 10) within the fluid passageway 106. Surface properties of the inner wall 108 may increase the velocity of the fluid near the inner wall 108, reducing the change in velocity of the fluid across the velocity gradient 116 from the inner wall 108 to the center of the fluid passageway 106.

The inner wall 108 may be formed with surface properties (e.g., surface characteristics) that increase the lifespan and efficiency of the heat exchanger 104 such as hydrophobic or superhydrophobic characteristics. Hydrophobic and superhydrophobic surfaces may repel the adhesion of fluid to the inner wall 108 and may decrease the amount of fouling and pressure loss within the fluid passageways 106. Hydrophobic materials have a contact angle of about 90 degrees or greater. Superhydrophobic materials have a contact angle of about 150 degrees or greater. These contact angles refer to using water as a fluid medium, but the surface characteristics may apply to a wide range of fluids, such as molten salts, gas coolants (such as He, N₂, SCO₂, and air). The surface characteristics may include, but are not limited to, surface roughness of the inner wall 108. Without being bound by any theory, it is believed that the increased surface roughness of the inner wall 108 increases surface wettability of the inner wall 108. The inner wall 108 may be configured to at least partially exhibit a hydrophobic surface texture. The hydrophobic surface texture may facilitate reduced fouling and or reduced pressure loss in the fluid passageway 106. The hydrophobic surface texture may be defined by the inner wall 108 including several column-like protrusions 114 extending into the fluid passageway 106. The protrusions 114 may exhibit an arithmetic mean surface roughness (Ra) along a length of the inner wall 108 with values ranging from about 1 μm to about 75 μm, such as from about 5 μm to about 75 μm, from about 10 μm to about 75 μm, from about 20 μm to about 75 μm, from about 30 μm to about 75 μm, from about 40 μm to about 75 μm, or from about 45 μm to about 75 μm. The protrusions 114 may be spaced apart about 400 μm or less from one another. In some embodiments the protrusions 114 may be spaced apart about 200 μm or less from one another, about 100 μm or less from one another, about 50 μm or less from one another, or about 25 μm or less from one another. The hydrophobic surface texture may include any of the surface characteristics discussed herein.

The surface characteristics of the inner wall 108 may be tailored during formation of the heat exchanger 104 in order to obtain the desired surface characteristics of the inner wall 108. The fluid passageway 106 may be formed through an additive manufacturing process. The additive manufacturing process may facilitate increased compactness and increased design complexity compared to conventionally formed fluid passageways of heat exchangers. In some embodiments, the fluid passageway 106 may be formed by directed energy deposition (DED) additive manufacturing. DED is a 3D printing process that uses a focused energy source, such as a plasma arc, laser or electron beam to melt a material that is simultaneously deposited by a nozzle. The DED method of forming the fluid passageway 106 may include, but is not limited to, Laser Engineered Net Shaping (LENS), Direct Metal Deposition (DMD), Electron Beam Additive Manufacturing (EBAM), Directed Light Fabrication, Laser Powder Bed Fusion (LPBF), or 3D Laser Cladding.

The DED process may facilitate tailoring (e.g., adjusting) the surface characteristics of the inner wall 108 of the fluid passageway 106. Parameters of the DED process that may be adjusted to achieve the desired surface roughness include input power, scan speed, powder feed rate, hatch spacing, layer height, fill toolpath, feed material and feed particle size. Input power may be measured as the power from an external source and input into an apparatus performing the DED process. Scan speed correlates to the speed at which the input energy source and powder delivery device move (e.g., traverse) relative to the workpiece during deposition. Powder feed rate is the rate at which the powder is deposited from a source onto the working area of the DED process. Hatch spacing is the distance between each pass and pathway of material deposition during DED. Layer height is a measurement of the height of material deposited for each layer of the part being fabricated. Fill toolpath is a measure of the angle at which the hatch layers are deposited by the apparatus performing the DED process relative to the surface the hatch layers are being placed on.

Changing one or more of the process parameters used during manufacturing of the heat exchanger 104 may change the resulting surface characteristics of the inner wall 108 of the fluid passageway 106. The process parameters may be selected to result in increased roughness of the inner wall 108. Alternatively, the process parameters may be selected to result in decreased roughness of the inner wall 108. A decrease in input power or scan speed may result in more deviations from planarity on the inner wall 108 and, therefore, rougher surface characteristics. Increases in any one or more of powder feed rate, hatch spacing, layer height, fill toolpath, and or feed particle size may increase surface roughness in the fluid passageway 106. The surface roughness factor of the inner wall 108 may be within a range from greater than about 1.0 to about 2.5. In some embodiments, the surface roughness factor is within a range of greater than about 1.0 to about 2.3 or greater than about 1.0 to about 2.0. The surface roughness factor of the inner wall 108 may be consistent along the entire length of the fluid passageway 106. In some embodiments, the surface roughness factor of the inner wall 108 may vary along the length of the fluid passageway 106. In some embodiments, the input power used during the DED process may be within a range from about 10 W to about 1000 W, from about 50 W to about 750 W, from about 100 W to about 500 W, or about 250 W. In some embodiments, the scan speed used during the DED process may be within a range from about 2 mm/s to about 20 mm/s, from about 5 mm/s to about 15 mm/s or about 8.5 mm/s. In some embodiments, the power feed rate may be within a range from about 1 g/min to about 20 g/min, from about 3 g/min to about 10 g/min, from about 7 g/min to about 20 g/min, or about 7 g/min. In some embodiments, the hatch spacing may be within a range from about 0.05 mm to about 5 mm, from about 0.1 mm to about 2 mm, or about 0.4 mm. In some embodiments, the layer height may be within a range from about 0.05 mm to about 3 mm, from about 0.1 mm to about 1 mm, or about 0.25 mm. In some embodiments, the feed material may be selected based on its conductive properties and/or compatibility with the DED process, such as one or more metals, powders, or wires. In some embodiments, the feed particle size may be within a range from about 5 μm to about 250 μm, such as from about 5 μm to about 200 μm or from about 45 μm to about 150 μm.

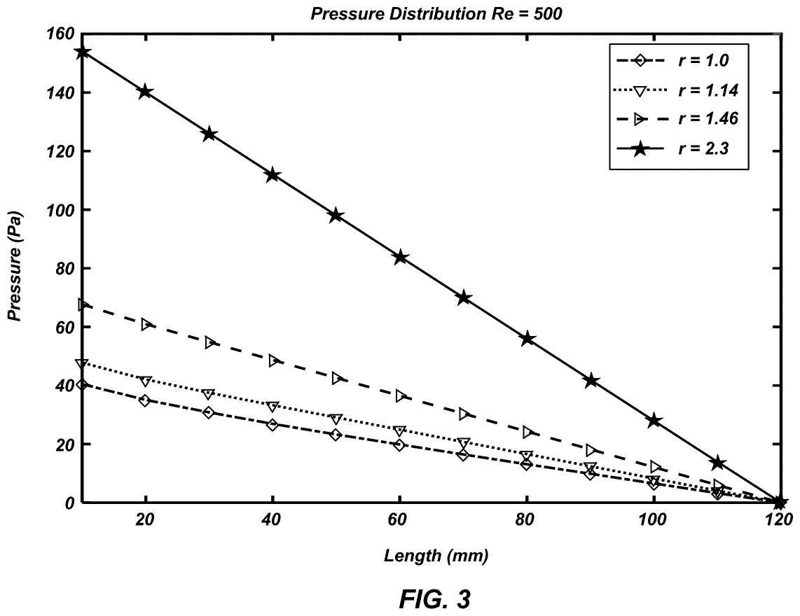

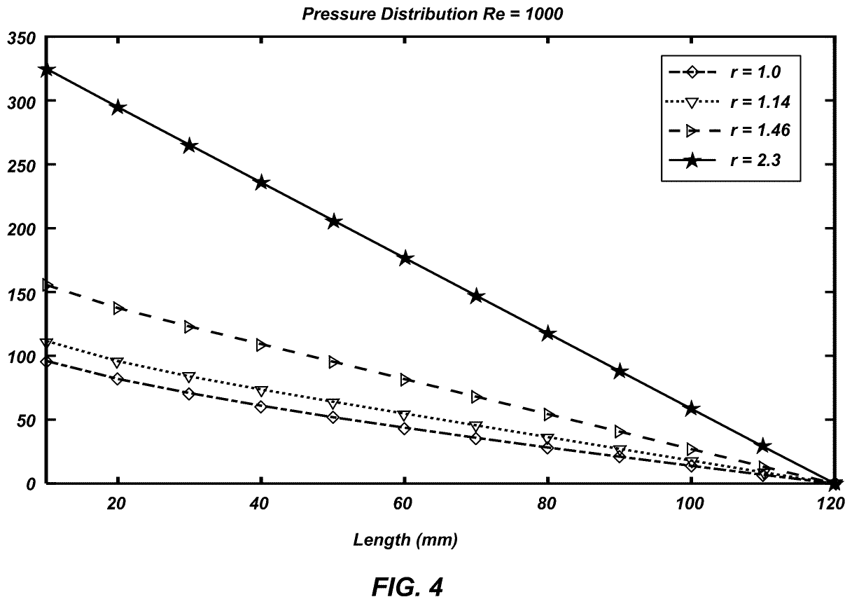

Referring to FIGS. 3 and 4, a relationship between roughness factor and pressure drop may be observed along the length of a portion of the fluid passageway 106. In some embodiments, as a roughness factor of the fluid passageway 106 increases, the pressure drop may also increase. Sample fluid passageways 106 were fabricated with DED. The sample fluid passageways 106 were fabricated on an Optomec MTS 500 LENS A20CA. 316L stainless steel powder feedstock material was used, and the powder feedstock had an average particle size from about 45 μm to about 150 μm. The DED process used a power of 250 W, a scan speed of 8.47 mm/s, a power feed rate of 6.79 g/min, a hatch spacing of 0.04064 mm, a layer height of 0.254 mm, and a fill toolpath of 30° rotation. Fluid passageways 106 from about 0.2 mm to about 3.2 mm in diameter were produced, where the diameter of each fluid passageway 106 was decreased by a given value, such as about 0.6 mm. The fluid passageway 106 lengths were about 12.7 mm or about 25.4 mm. The measurements and data discussed below are based on analysis of the fluid passageways 106. Samples were cut through the center of the fluid passageways 106 using wire electrical discharge machining. The fluid passageways 106 were imaged using laser-optical microscopy on a Keyence VK-X200. Roughness on the inner flow channel was measured for the average arithmetic mean roughness (Ra) and roughness factor along the length of the fluid passageways 106. FIG. 3 shows the pressure drop of various roughness factors, the data having a Reynolds number of 500 and FIG. 4 shows the pressure drop of various roughness factors, the data having a Reynolds number of 1000. A trend of increased pressure drop with higher roughness factors was observed.

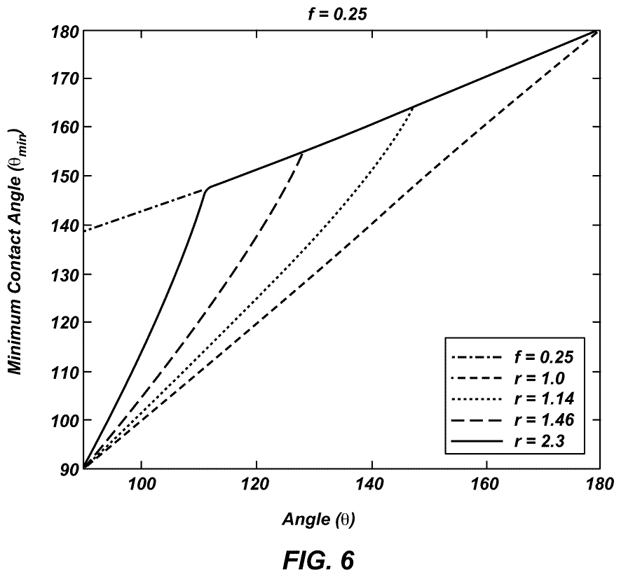

Referring to FIG. 6, a relationship between roughness factor and thermal-hydraulic performance was observed. In some embodiments, as the roughness factor increases, the thermal-hydraulic performance may increase. Table 1 below compares the thermal-hydraulic performance of the heat exchangers with different Reynolds numbers and roughness factors. FIG. 6 is a graphical representation of the thermal-hydraulic performance of each roughness factor having a Reynolds number of 500. A trend of increased thermal-hydraulic performance with higher roughness factors was observed.

TABLE 1

| | Roughness Factor | | | |
|---|---|---|---|---|
| | h (W/m²/K) | | Nu | |
| Reynolds Number | Re = 500 | Re = 1000 | Re = 500 | Re = 1000 |
| 1 | 767 | 1232 | 3.32 | 5.34 |
| 1.14 | 798 | 1339 | 3.46 | 5.80 |
| 1.46 | 853 | 1432 | 3.70 | 6.21 |
| 2.30 | 1008 | 1651 | 4.37 | 7.15 |

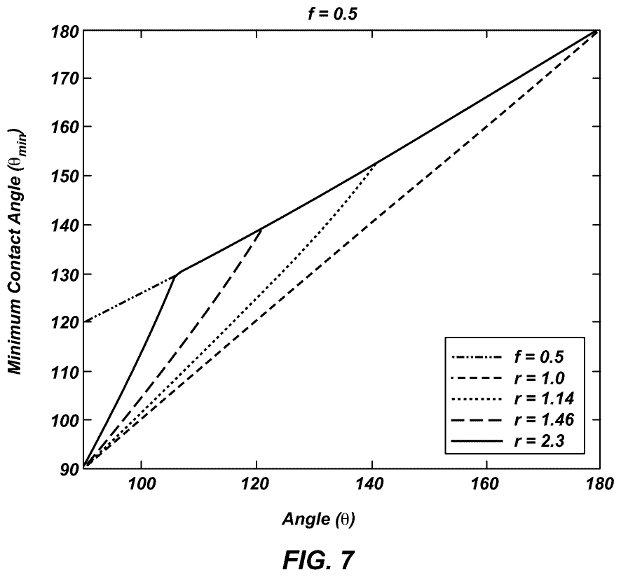

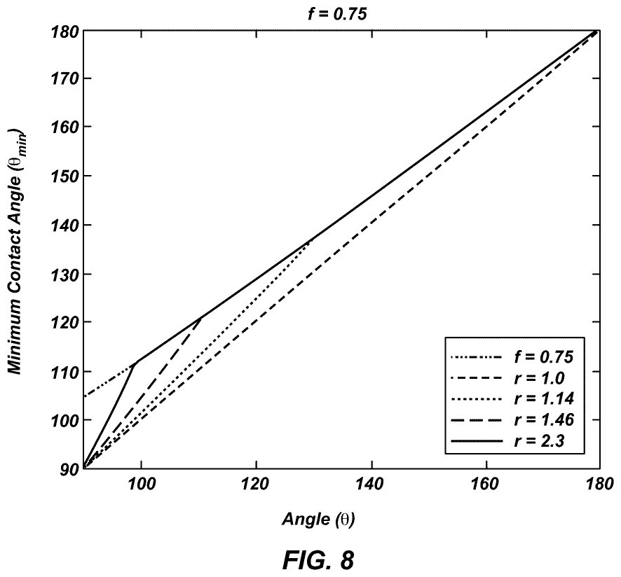

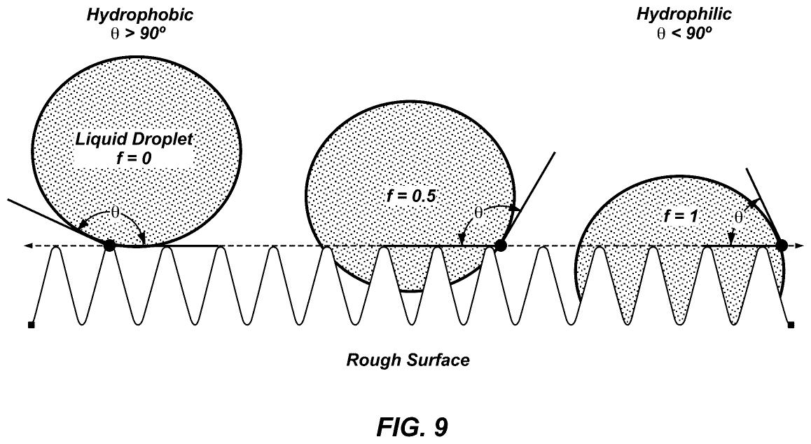

FIGS. 6-8 show the minimum contact angle when comparing the Cassie-Baxter and Wenzel regimes for estimating contact angle at various roughness factors and solid-liquid fractions. The data shown in FIGS. 6-8 refer to simulated analysis of the sample fluid passageways 106. The Cassie-Baxter model refers to a state where droplets may trap air in the volume between the protrusions 114 on the inner wall 108 and droplet. The Wenzel regime refers to a state where droplets fill space between the protrusions 114 on the inner wall 108. FIG. 9 is a schematic of various solid-liquid fractions and contact angles of a liquid droplet on a rough surface.

The Wenzel regime contact angle (θ_{W}) is calculated with the roughness factor (r) and measured contact angle (θ) with equation (1).

$$cos {θ}_{W} = r cos θ \qquad ( 1 )$$

Roughness factor is calculated with the length of the solid-liquid interface (Lₛ₋ₗ) and length of the projected flat plane (Lₚ) in equation (2).

$$r = \frac{{L}_{s - l}}{{L}_{p}} \qquad ( 2 )$$

The Cassie-Baxter regime contact angle (θ_{C}) is calculated with the solid-liquid fraction (f) in equation (3).

$$cos {θ}_{C} = f ( cos θ + 1 ) - 1 \qquad ( 3 )$$

For contact angles below θ=90°, the Wenzel regime contact angle (θ_{W}) for all roughness factors shown in FIGS. 6-8 did not meet the criterion for hydrophobicity and r=1.0, showed the largest θ_{W}. Based on the Wenzel equation, fluids that may exhibit a small, measured contact angle with the solid surface (θ<90°) may have reduced potential for hydrophobicity when comparing a rough surface to a smooth one. The opposite trend may be observed at (θ>90°), where the largest θ_{W} may be observed at highest roughness factor (r=2.3). Within the Wenzel regime, increased roughness factor may lead to an increase potential for hydrophobic surface properties above θ=90°.

Cassie regime contact angle may be governed by the effect of the solid-liquid fraction. The minimum values of θ_{C} may occur when f=1.0, or full contact with the fluid along the inner wall 108. Contact angle may grow larger as f approaches the minimum value (f=0), or zero contact with the fluid along the inner wall 108. When considering the condition for hydrophobicity that occurs at θ_{C}>90°, it was observed that a decrease in f led to an increase in potentially hydrophobic properties. The roughness condition applied in the Wenzel regime states that an increase in solid boundary length may tend towards a higher contact angle. A decrease in solid-liquid fraction at the interface may occur. A corrugated wall with increasing r value may exhibit improved hydrophobic properties when in contact with a given fluid.

The dominant apparent contact angle (θ_{W} or θ_{C}) will be towards the smaller value. The minimum apparent contact angles values for both models that occur at r=1 and f=1 result in θ=θ_{W}=θ_{C}. Thus, the minimum contact angle for all roughness factors may be considered the θ_{W} at r=1. The maximum case in the Cassie regime is where f=0, θ_{C}=180° For all contact angles. Therefore, the minimum angle between the regimes at f=0 may correspond to the Wenzel regime. As solid-liquid fraction increases, θ_{C} decreases and the minimum contact angle between both models becomes dominated by the Cassie regime for all roughness factors. As the roughness factor increases, the angle at which θ_{W}=θ_{C} decreases.

Increasing the roughness factor or solid-liquid fraction of the inner wall 108 may decrease the minimum contact angle observed between the Cassie-Baxter regime and the Wenzel regime. Therefore, higher roughness factors and lower solid-liquid fractions may lead to higher hydrophobic characteristics and improved heat transfer in the heat exchanger 104. An increase in the hydrophobic characteristics of the inner wall 108 may facilitate cleaner operation of the heat exchanger.

Computational fluid dynamic (CFD) simulations may be utilized, in a software such as Star-CCM+, to examine effects of surface characteristics of the inner wall 108 on the performance, design, and potential for hydrophobicity of the heat exchanger 104. In some embodiments, the CFD simulations may utilize a 2D model, which may represent a two-channel parallel flow heat exchanger 104 fabricated with additive manufacturing. A non-limiting example of input parameters (e.g., operating conditions and geometric parameters) for the CFD simulations are found in Table 2 below.

TABLE 2

| Property | Hot Channel | | Cold Channel | |
|---|---|---|---|---|
| Inlet Temperature | 300 | | 20 | |
| (C.) | | | | |
| Outlet Pressure (Pa) | 0 | | 0 | |
| Reynolds Number | 500 | 1000 | 500 | 1000 |
| Inlet velocity (m/s) | 0.02341 | 0.04683 | 0.18824 | 0.37648 |

| | |
|---|---|
| Channel diameter | 2.6 |
| (mm) | |
| Wall thickness | 1.0 |
| (mm) | |
| Channel length | 120 |
| (mm) | |

In addition to the parameters listed above, the flow in the fluid passageways 106 may be considered incompressible fluids and simulations may be run assuming constant materials properties across the entire channel, non-limiting, exemplary characteristics for water are listed in Table 3 below.

TABLE 3

| Property | Hot Channel | Cold Channel |
|---|---|---|
| Density (kg/m³) | 725.6 | 998.1 |
| Specific Heat (KJ/kg/K) | 3.0387 | 4.183 |
| Dynamic viscosity (Pa · s) | 0.0000839 | 0.000977 |

| | |
|---|---|
| Thermal Conductivity (W/m/K) | 0.6 |
| Structural Material Thermal | 14.6 |

Conductivity (W/m/K)

Other nonlimiting conditions used in the CFD simulations may include Dirichlet boundary conditions of each fluid passageway 106. The inlet velocity shown in Table 1 may be prescribed at the inlet 110 of the fluid passageway 106 and a 0 Pa average pressure condition may be prescribed at the outlet 112 of the fluid passageway 106. The inner wall 108 may be considered an adiabatic boundary. The convergence criterion for conservation of mass, momentum, and energy equations may be about 10⁻⁸ residuals.

Analysis of the heat exchanger 104 in the CFD simulation may be performed within the hot or cold channel. To determine hydraulic performance, the friction factor (ƒ) may be calculated from the pressure drop (ΔP) using equation (4).

$$f = \frac{2 Δ {PD}_{h}}{ρ {v}^{2} L} \qquad ( 4 )$$

The friction factor based on the pressure drop may be compared to the friction factor from the Colebrook equation (5), the Colebrook equation is used to incorporate the effect of relative pipe surface roughness into heat exchanger analysis.

$$\frac{1}{\sqrt{f}} = - 2. log ( \frac{\frac{{k}_{s}}{{D}_{h}}}{3.7} + \frac{2.5}{Re \sqrt{f}} ) \qquad ( 5 )$$

The relationship between arithmetic mean roughness (Ra) and relative sand grain roughness (kₛ) used in the Colebrook equation may be defined with equation (6).

$${k}_{s} = 11.03 {R}_{a} \qquad ( 6 )$$

The arithmetic mean roughness of a sinewave corrugated wall surface may be determined by equation (7).

$${R}_{a} = \frac{1}{L} {\int }_{0}^{L} \vert Z ( x ) \vert dx \qquad ( 7 )$$

To determine convective heat transfer within the flow, the following equation, equation (8), may be used to calculate the convective coefficient (h):

$$h = \frac{{c}_{p} \dot{m}}{{A}_{s}} \frac{Δ {T}_{in}}{Δ {T}_{stream}} \qquad ( 8 )$$

ΔTᵢₙ is the total change in temperature from inlet to outlet of the fluid passageway, and ΔTₛₜᵣₑₐₘ is the temperature difference between the inner wall 108 and the center of the fluid passageway 106. The heat transfer surface area (Aₛ) may be considered for the inner wall 108 of the fluid passageway 106. From h, the Nusselt number (Nu) may be calculated to analyze overall heat exchanger performance using equation (9):

$$Nu = \frac{h}{k} {D}_{h} \qquad ( 9 )$$

The overall heat exchanger performance of the corrugated wall compared to the straight channels may be evaluated using a thermo-hydraulic performance parameter (THPP) factor calculated in equation (10), where Nu₀ and ƒ₀ may be values of the straight channel cases.

$$THPP = \frac{\frac{Nu}{{Nu}_{0}}}{{( \frac{f}{{f}_{0}} )}^{\frac{1}{3}}} \qquad ( 10 )$$

General trends observed with the analysis of the CFD simulations above are that arithmetic mean roughness (Rₐ) increases with increased amplitude and surface roughness factor increased with increasing amplitude and with decreasing period.

The embodiments of the disclosure described above and illustrated in the accompanying drawing figures do not limit the scope of the disclosure, since these embodiments are merely examples of embodiments of the disclosure, which is defined by the appended claims and their legal equivalents. Any equivalent embodiments are intended to be within the scope of this disclosure. Indeed, various modifications of the present disclosure, in addition to those shown and described herein, such as alternative useful combinations of the elements described, will become apparent to those of ordinary skill in the art from the description. Such modifications and embodiments also fall within the scope of the appended claims and their legal equivalents.

What is claimed is:

1. A method of forming a heat exchanger, comprising:
selecting process parameters for a directed energy deposition (DED) additive manufacturing process for forming a housing and channels within the housing of a heat exchanger; and
forming the channels within the housing using the process parameters of the DED additive manufacturing process, inner walls of the channels having hydrophobic or superhydrophobic surface properties,
wherein the inner walls of the channels exhibit an as-fabricated surface roughness factor within a range from greater than about 1.0 to about 2.5.

2. The method of claim 1, wherein selecting process parameters comprises selecting one or more of input power, scan speed, powder feed rate, hatch spacing, layer height, fill toolpath, feed material and/or feed particle size of the DED additive manufacturing process.

3. The method of claim 2, wherein selecting process parameters for a DED additive manufacturing process comprises selecting the input power to be 250 W, the scan speed to be 8.47 mm/s, the powder feed rate to be 6.79 g/min, the hatch spacing to be 0.4064, the layer height to be 0.254, the fill toolpath comprises 30° rotation, the feed material to be 316L stainless steel and/or the feed particle size to be between about 45 μm and about 150 μm.

4. The method of claim 1, wherein forming the channels comprises forming the inner walls of the channels having hydrophobic surface properties.

5. The method of claim 1, wherein using the process parameters to form the channels by the DED additive manufacturing process comprises forming the inner walls of the channels to exhibit a hydrophobic surface structure on the inner walls of the channels.

6. The method of claim 1, wherein selecting process parameters for the DED additive manufacturing process for forming channels of a heat exchanger further comprises calculating performance of the heat exchanger based on surface properties of the inner walls of the channels.

7. The method of claim 6, wherein calculating performance of the heat exchanger based on surface properties of the inner walls of the channels comprises calculating an apparent contact angle of fluid within the channels relative to the inner walls of the channels.

8. The method of claim 7, wherein calculating the apparent contact angle of fluid within the channels relative to the inner walls of the channels comprises using Wenzel and/or Cassie-Baxter regimes.

9. A heat exchanger, comprising:
a housing; and
channels within the housing and defining fluid passageways, inner walls of the channels exhibiting high, as-fabricated hydrophobic or superhydrophobic surface properties,
the channels exhibiting an inner diameter within a range from about 0.1 mm to about 5 mm.

10. The heat exchanger of claim 9, wherein the inner walls of the channels exhibit a hydrophobic surface texture.

11. The heat exchanger of claim 9, wherein the fluid passageways are configured to exhibit a contact angle between a fluid passing therethrough and the inner walls of the channels greater than about 90°.

12. The heat exchanger of claim 9, wherein the inner walls of the channels exhibit a roughness factor within a range of from greater than about 1.0 to about 2.5.

13. The heat exchanger of claim 9, wherein the channels define at least a first set of fluid passageways and a second set of fluid passageways, wherein the first set of fluid passageways and the second set of fluid passageways pass through the housing in different directions.

14. A reactor assembly, comprising:
a nuclear reactor; and
a heat exchanger operatively connected to the nuclear reactor, the heat exchanger comprising:
channels distributed throughout the heat exchanger, inner walls of the channels exhibiting hydrophobic or superhydrophobic surface properties.

15. The reactor assembly of claim 14, wherein a solid-liquid fraction within the channels is within a range from 0 to about 0.75.

16. The reactor assembly of claim 14, further comprising a gas or a molten fluid within the channels.

17. The reactor assembly of claim 14, wherein the heat exchanger is configured as one of: a plate and frame heat exchanger, a brazed plate welded plate heat exchanger, a plate-fin heat exchanger, a brazed plate-fin heat exchanger, a diffusion-bonded plate-fin heat exchanger, a spiral heat exchanger, a plate and shell heat exchanger, or a polymer or printed circuit heat exchanger.

18. The reactor assembly of claim 14, wherein the inner walls of the channels exhibit an as-fabricated surface roughness factor within a range of from greater than about 1.0 to about 2.5.

19. The reactor assembly of claim 18, wherein the as-fabricated surface roughness factor is 2.3.

20. The reactor assembly of claim 14, further comprising one or more compressors and one or more turbines in fluid connection with the heat exchanger.
